(19) United States
(12) Patent Application Publication
(10) Pub. No.: US 2008/0290176 A1
(43) Pub. Date: Nov. 27, 2008

(54) METHODS AND DEVICES WITH A CIRCUIT FOR CARRYING INFORMATION ON A HOST

(75) Inventor: Robert C. Fleet, Montclair, CA (US)

Correspondence Address: KELLY LOWRY & KELLEY, LLP, 6320 CANOGA AVENUE, SUITE 1650, WOODLAND HILLS, CA, 91367, US

(73) Assignee: PRECISION DYNAMICS CORPORATION, San Fernando, CA (US)

(21) Appl. No.: 11/752,129

(22) Filed: May 22, 2007

(51) Int. Cl. G06K 19/06

(52) U.S. Cl. 235/492

(57) ABSTRACT

A band, label or tagging device for carrying identifying information about a person or object. The device includes a circuit host and antenna disposed on different substrates such that the substrates must be bonded together during the manufacturing stage in order to form a workable identification circuit. The bonding medium between the first and second substrates is such that upon an attempt to tamper with or remove the device, the first and second substrates will separate thus separating the circuit host from the antenna and disabling the communication circuit. The communication circuit may also comprise a circuit host with transponder and an antenna placed within the communication range of the transponder. Alternatively, the circuit may comprise two circuit hosts and two transponders placed within communication range of each other thus forming an enhanced ranged communication circuit.

### BACKGROUND OF THE INVENTION

The present invention generally relates to improved identification devices having a circuit for carrying information on a host. More particularly, the present invention relates to improved devices for enabling and disabling circuits on identification devices.

A wristband, tag or label having a circuit host for carrying information is known in the art. Such identification devices typically consist of a circuit host coupled to an antenna mounted on or laminated between polymer substrates. The circuits on such identification devices can be configured for enablement upon construction or enablement upon completion of a circuit loop, i.e., as in encircling a wristband around a person's wrist.

Similarly, such identification devices provide for disabling of the circuit on the identification device in the event of tampering, stretching and/or removal of the device. This disabling is typically achieved through the use of a frangible loop of conductive material that traces the length of the device. Disabling of the circuit occurs when the frangible loop is torn or broken following an attempt to tamper with, tear and/or remove the device.

Drawbacks of such prior art devices for disabling a circuit include the possibility of opening a wristband loop without cutting, stretching or tearing the frangible circuit loop around the perimeter of the device. Such removal can result in an identification device being removed without the circuit being disabled.

Accordingly, there is a need for an improved identification device wherein an attempt to remove the identification device from a surface to which it is adhered will result in failure of the circuit and disablement of the same.

### SUMMARY OF THE INVENTION

A device in the nature of a wristband, tag or label for identifying an object or person. The device consists of a first substrate and a second substrate bonded together by a first bonding layer disposed there between. The first bonding layer is substantially coextensive with both the first substrate and the second substrate. The first substrate has a circuit host bonded or printed on a side that faces the second substrate. The second substrate has an antenna bonded or printed on a side that faces the first substrate. The first bonding layer does not cover the circuit host on the first substrate. The first substrate is aligned with and bonded to the second substrate such that at least a portion of the antenna aligns with at least a portion of the circuit host. This aligning of the antenna and the circuit host places the two in electrical communication. The first bonding layer has an adhesive strength less than the adhesive strength of the bond between the circuit host and the first substrate as well as the bond between the antenna and the second substrate. In this way an attempt to remove the device from a person or object will result in failure of the first bonding layer and the circuit host being separated from the antenna. This separation results in a disabling of the circuit host antenna combination.

A conductive adhesive may be disposed between the aligned portions of the antenna and the circuit host. This conductive adhesive bonds the aligned portions of the antenna and the circuit host thereby facilitating the electrical communication between the two.

A second bonding layer may be disposed over a portion of a second side of either the first or second substrate. A release layer covers this second bonding layer. Removal of the release layer permits the second bonding layer to affix the device to a surface, person or object to be identified. As with the other bonds, the first bonding layer has an adhesive strength less than the adhesive strength of the second bonding layer. In this way an attempt to remove the device will result in failure of the first bonding layer and separation of the first substrate from the second substrate. This separation results in separation of the circuit host from the antenna and disablement of the device.

The antenna is preferably a continuous loop of conductive material that traverses substantially the entire length of the second substrate. In addition, the antenna is made from a frangible material and placed adjacent to the perimeter of the second substrate. In this way attempts to cut, remove or stretch the identification device will likely result in cutting or breaking of the antenna and disablement of the identification device.

As mentioned above, the identification device will be disabled if the circuit host is separated from the antenna or if the antenna is cut or broken. The circuit host is preferably programmed to erase all data stored therein if the identification device becomes disabled. In addition, the circuit host can be programmed with an electronic alarm signal configured to activate if the identification device becomes disabled.

In another embodiment the circuit host may comprise a first circuit host and a first transponder. In this embodiment, the antenna will be aligned with the circuit host such that it is in communication range of the first transponder. Ideally, the first transponder has a send-receive range less than the thickness of the first substrate.

In another embodiment, the antenna may comprise a second circuit host and a second transponder. In this embodiment, the second transponder is aligned with the first transponder such that they are in communication range of each other. These coupled transponders form an enhanced range communication circuit. Where there are two circuit hosts, both are programmed such that they are not enabled until the first and second transponders are brought into communication range, thus forming the enhanced range communication circuit. Preferably, each transponder has a unique encrypted lock and key identifier.

Other features and advantages of the invention will become more apparent from the following detailed description taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a cross-sectional view of an identification wristband of the present invention;

FIG. 2 is a cross-sectional view of a wristband of the present invention illustrating separation of the circuit host and antenna;

FIG. 3 is an enlarged cross-section of a portion of the wristband of FIG. 1 illustrating the alignment of the circuit host and antenna;

FIG. 4 is an enlarged cross-section of a portion of the wristband of FIG. 1 illustrating an alternate alignment of the circuit host and antenna;

FIG. 5 is a cross-sectional view taken along line 5-5 of FIG. 1;

FIG. 6 is a cross-sectional view similar to FIG. 5 illustrating an alternate configuration for the antenna;

FIG. 7 is a cross-sectional view similar to FIG. 5 illustrating an alternate configuration for the antenna;

FIG. 8 is a cross-sectional view of a label of the present invention illustrating configuration of the circuit host and antenna;

FIG. 9 is a cross-sectional view of a self-wrapping tag of the present invention illustrating the circuit host and antenna configuration;

FIG. 10 illustrates a sheet including a wristband and multiple labels embodying the present invention;

FIG. 11 is a cross-sectional view of FIG. 10 taken along line 11-11;

FIG. 12 is an alternative cross-sectional view of the wristband of FIG. 1 illustrating alignment of the circuit host having a portion of an antenna in alignment with a larger antenna;

FIG. 13 is a cross-sectional view of a wristband of the present invention embodying an enhanced-range communications circuit having a transponder placed within communication range of another antenna;

FIG. 14 is a cross-sectional view of FIG. 13 taken along line 14-14;

FIG. 15 is a cross-sectional view of a wristband of the present invention illustrating the placement of a first circuit host/first transponder and second circuit host/second transponder;

FIG. 16 is an enlarged view of one end of a wristband of the present invention including stress cuts or perforations placed between the circuit host and antenna;

FIG. 17 is an alternative embodiment of FIG. 16 illustrating angled perforations;

FIG. 18 is an alternative embodiment of FIG. 16 illustrating a series of parallel perforations;

FIG. 19 is a cross-sectional view of a wristband of the present invention illustrating an embodiment where the circuit host connects to an antenna; and

FIG. 20 is an enlarged cross-sectional view a wristband of the present invention illustrating a circuit host having an electronic alarm signal.

### DETAILED DESCRIPTION OF THE PREFERRED EMBODIMENTS

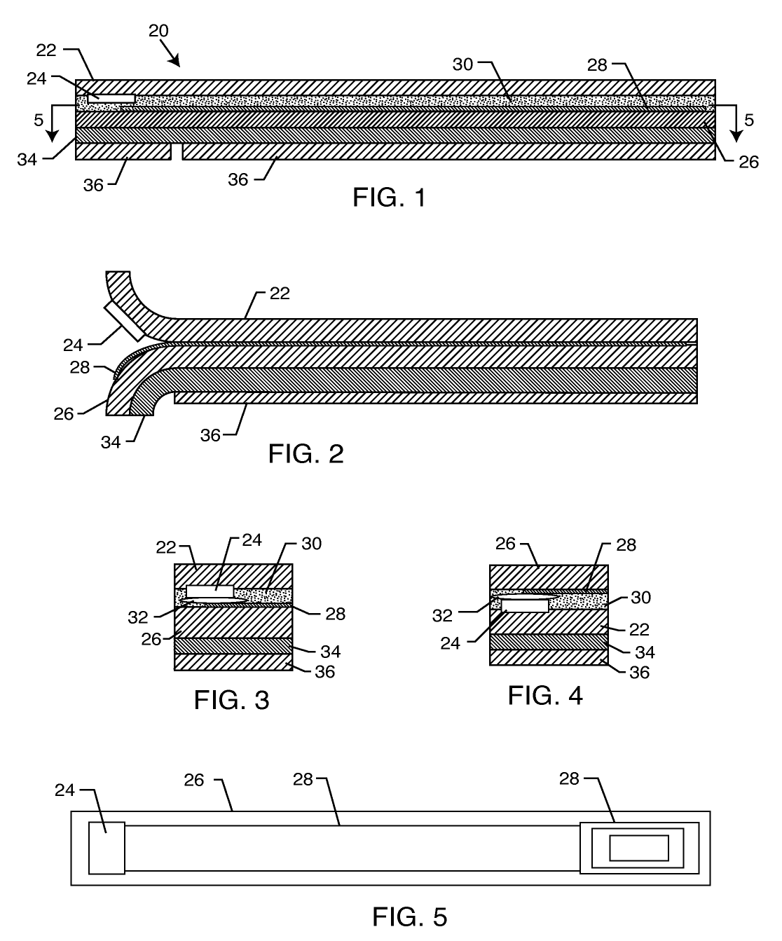

The present invention is directed to an identification device in the nature of a wristband, tag or label for carrying identification information about a person or object. As shown in FIG. 1, the identification device may be a wristband 20 designed for wrapping around a person or object and securing by adhesive means. The wristband 20 consists of a first substrate 22 having a circuit host 24 bonded or printed on one side thereof. A second substrate 26 has an antenna 28 bonded or printed on one side thereof. The first substrate 22 and second substrate 26 are preferably constructed from a durable polymer material typically used in identification devices such as wristbands, tags or labels.

A first bonding layer 30 is disposed between the first substrate 22 and the second substrate 26. The first bonding layer 30 is substantially coextensive with both the first substrate 22 and the second substrate 26. However, the first bonding layer 30 should not cover the circuit host 24.

The first substrate 22 is aligned with and bonded to the second substrate 26 by means of the first bonding layer 30. In aligning the first substrate 22 with the second substrate 26 the circuit host 24 and antenna 28 should be on adjacent sides of the respective substrates. At least a portion of the antenna 28 must align with at least a portion of the circuit host 24 such that they are in electrical communication when the first substrate 22 and second substrate 26 are bonded together.

Critical to this invention is the relative adhesive strength of the first bonding layer 30 to the bonds between the circuit host 24 and first substrate 22 and the antenna 28 and the second substrate 26. The first bonding layer 30 must have an adhesive strength less than the adhesive strength of the bond between the circuit host 24 and the first substrate 22. Similarly, the first bonding layer 30 must have an adhesive strength less than the adhesive strength of the bond between the antenna 28 and the second substrate 26. The purpose for the relative bonding strengths is so that upon an attempt to tamper with and/or remove the wristband 20, the first bonding layer 30 will separate before the other bonds in the device resulting in a separation of the first substrate 22 from the second substrate 26. This separation will also result in a separation of the circuit host 24 from the antenna 28 as illustrated in FIG. 2, thus disabling the identification device.

FIGS. 3 and 4 illustrate the relative placement of the antenna 28 and circuit host 24. A conductive adhesive 32 may be disposed between the aligned portions of the antenna 28 and circuit host 24. This conductive adhesive 32 facilitates the connection between the antenna 28 and circuit host 24 thus ensuring electrical communication therebetween.

The wristband 20 may include a second bonding layer 34 disposed over at least a portion of a second side of either the first substrate 22 or the second substrate 26. A release layer 36 covers the second bonding layer 34 until it is needed to bond the device to a surface. A portion or all of the release layer 36 is removed and the wristband 20 may be secured to a surface by the second bonding layer 34 or secured around a person's wrist or an object by overlapping the ends of the wristband 20. As with the other relative strengths of the various bonds, the first bonding layer 30 has an adhesive strength less than the adhesive strength of the second bonding layer 34. Preferably, the adhesive strength of the second bonding layer 34 is at least as strong, if not stronger than, the bonds that exist between the first substrate 22 and circuit host 24 and second substrate 26 and antenna 28. As an additional preference, as illustrated in FIG. 2, the juncture of the circuit host 24 and the antenna 28 is positioned over a section of the release layer 36 that is removed and adhered to another surface or other end of the wristband 20. That is, the juncture of the circuit host 24 and the antenna 28 are positioned in a location where tampering of the wristband 20 is most likely to occur.

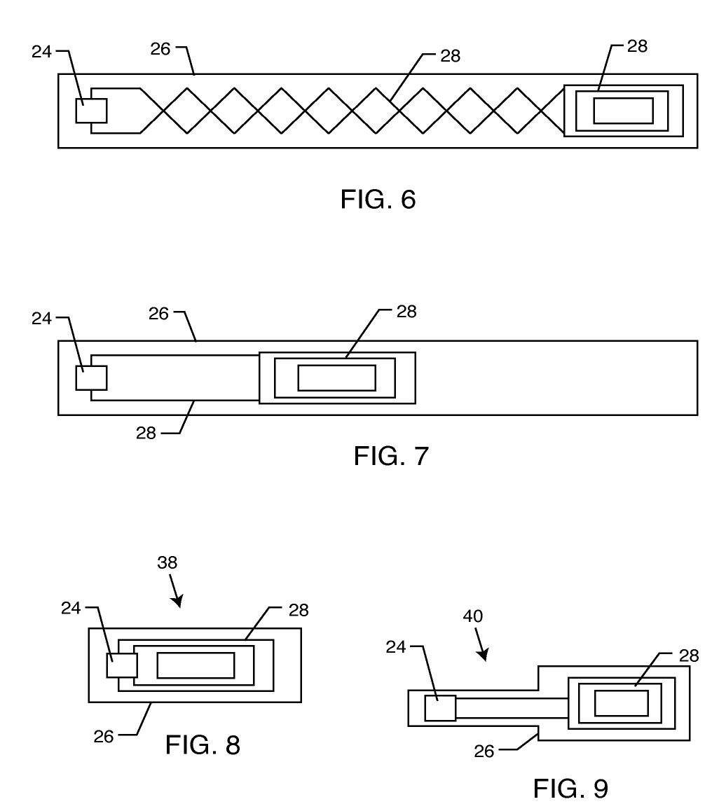

FIGS. 5-7 illustrate various configurations of the circuit host 24 and antenna 28. Preferably, the antenna 28 comprises a continuous loop of conductive trace material that traverses substantially the entire length of the second substrate 26. The antenna 28 is preferably made from a frangible material and is placed adjacent to the perimeter of the second substrate 26 as shown in FIG. 5. The antenna 28 may also traverse the surface of the second substrate 26 in various patterns, one of which is illustrated in FIG. 6. In addition, the antenna 28 need not traverse the entire length of the second substrate 26 as illustrated in FIG. 7.

FIGS. 8 and 9 illustrate alternate embodiments for the identification device of the present invention. FIG. 8 illustrates a label 38 and FIG. 9 illustrates a wrap-around tag 40. The construction of the label 38 and wrap around tag 40 is similar to the construction of the wristband 20. The label 38 and wrap around tag 40 both include a first substrate 22 with a circuit host 24 and a second substrate 26 with an antenna 28. A first bonding layer 30 disposed between the first substrate 22 and second substrate 26 bond the two layers together with the circuit host 24 and antenna 28 having the above stated aligned configuration. A conductive adhesive 32 may or may not be included between the circuit host 24 and antenna 28. A second bonding layer 34 and release layer 36 may be included on at least a portion of one side of the label 38 or wrap around tag 40 as with the wristband 20. As described above, the critical aspect of this invention is the relative adhesive strengths of the first bonding layer, second bonding layer and the bonds that exist between the first substrate 22 and circuit host 24, as well as, second substrate 26 and antenna 28. The first bonding layer 30 must have the weakest adhesive strength such that an attempt to tamper with or remove the identification device will result in failure of this first bonding layer 30 and separation of the first substrate 22 from the second substrate 26. As described above, this separation results in the separation of the circuit host 24 from the antenna 28 and disablement of the identification device.

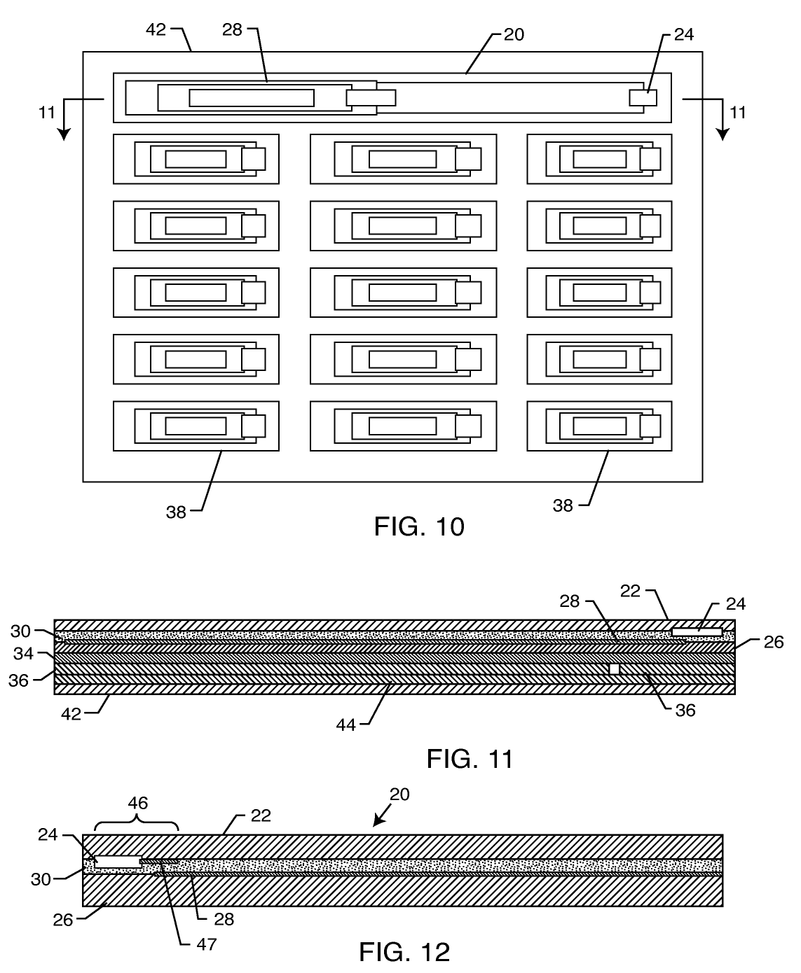

FIG. 10 illustrates a sheet media 42 that includes at least one wristband 20 and multiple labels 38. The sheet media 42 may also include multiple wrap around tags 40 (not shown) in place of several of the labels 38. FIG. 11 illustrates a cross-sectional view of the sheet media 42 taken along line 11-11. This cross-sectional view illustrates the sheet media 42 as the backing for the sheet and a third bonding layer 44 to adhere the identification devices to the sheet media 42.

FIG. 12 further illustrates an alternate embodiment of the wristband 20. A transponder 46 is formed from the combination of the circuit host 24 and a portion of a small antenna 47. The transponder 46 is encapsulated between the first substrate 22 and the second substrate 26 and effectively retained by the first bonding layer 30. Thus, it is evident from FIG. 12 that the circuit host 24 and the small antenna 47 combine to form the transponder 46 as placed adjacent to the antenna 28 to form a security mechanism similar to the one shown in separated form in FIG. 2. Upon an attempt to tamper with and/or remove the wristband 20, the first bonding layer 30 separates before the other bonds in the device resulting in a separation of the first substrate 22 from the second substrate 26. This separation also results in the separation of the transponder 46 from the antenna 28.

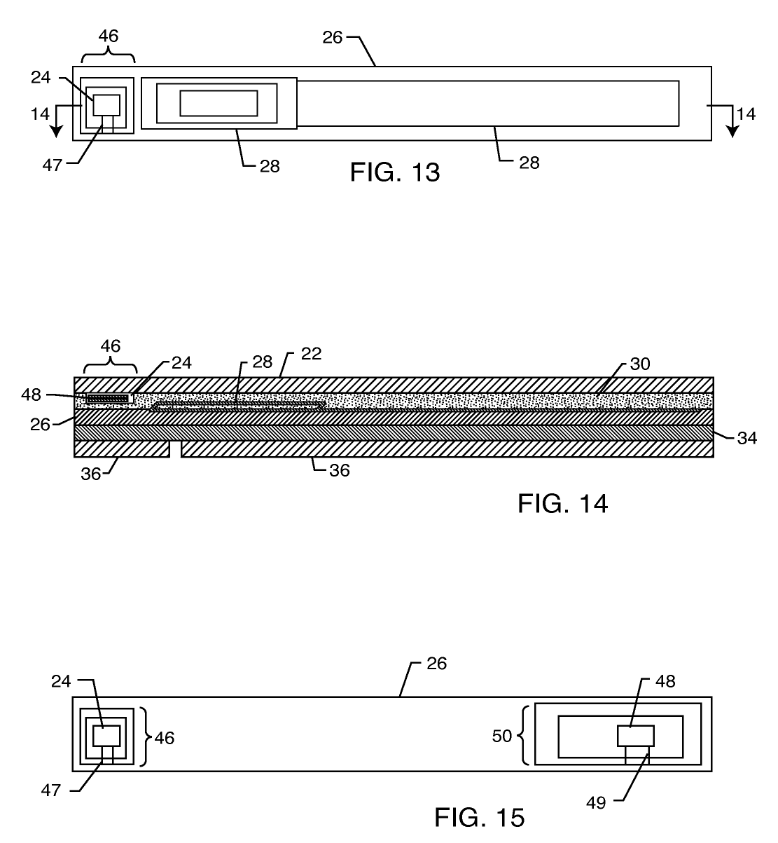

FIGS. 13 and 14 illustrate an alternate embodiment of the wristband 20 of FIG. 12. These FIGS. further illustrate an alternative embodiment of the transponder 46 as formed by the circuit host 24 and the small antenna 47. The transponder 46 has a communication or send/receive range less than the thickness of the first substrate 22. For operation, the antenna 28 must be aligned with the circuit host 24 such that the antenna 28 is within the communication range of the transponder 46. The antenna 28 coupled with the transponder 46 creates an enhanced-range communication circuit capable of communications with third party send/receive mechanisms. As in the other embodiments, the wristband 20 is designed to separate between the first substrate 22 and the second substrate 26 in the event of tampering or attempted removal of the wristband 20. In this way the transponder 46 is separated from the antenna 28 thereby disabling the enhanced-range communication circuit.

FIG. 15 depicts another alternate embodiment. In this embodiment, the circuit host 24 and the small antenna 47 form the transponder 46, previously described. Additionally, the antenna 28 in FIG. 12 is replaced by a second circuit host 48 incorporating a second small antenna 49 to form a second transponder 50. The first transponder 46 is coupled with the second transponder 50 to form the enhanced-range communication circuit as described above. In this embodiment the first and second circuit hosts 24, 48 are programmed such that they will not become enabled until the first transponder 46 is brought into communication range with the second transponder 50. The first and second transponders 46, 50 each possess a unique encrypted lock and key identifier.

As described above, the adhesive forces of the respective bonding layers are such that if there is an attempt to remove the device from a surface or a person's wrist, the bonding layer 30 between the first substrate 22 and the second substrate 26 will release before all other bonds, thus damaging or breaking the enhanced-range communication circuit formed by the coupling of the transponders 46, 50. This breaking of the enhanced-range communication circuit will disable the electronic communications capability of the device.

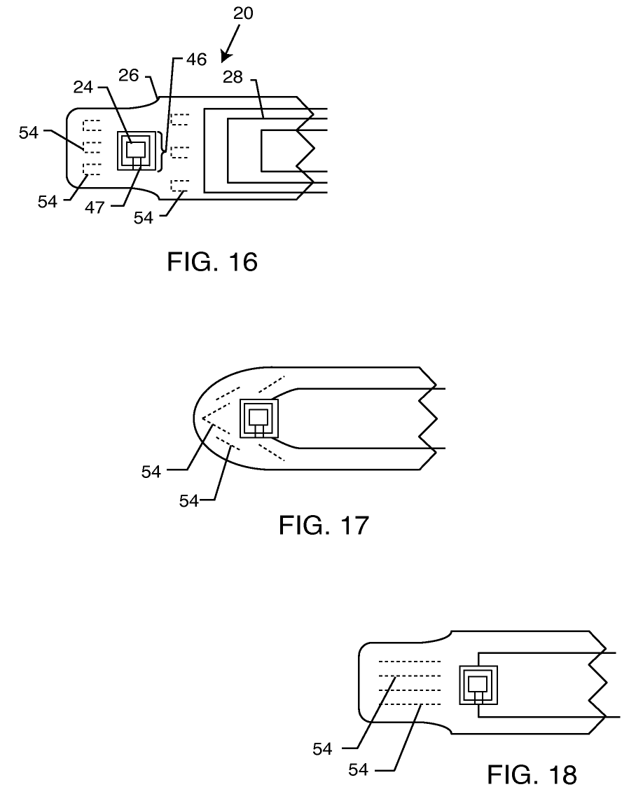

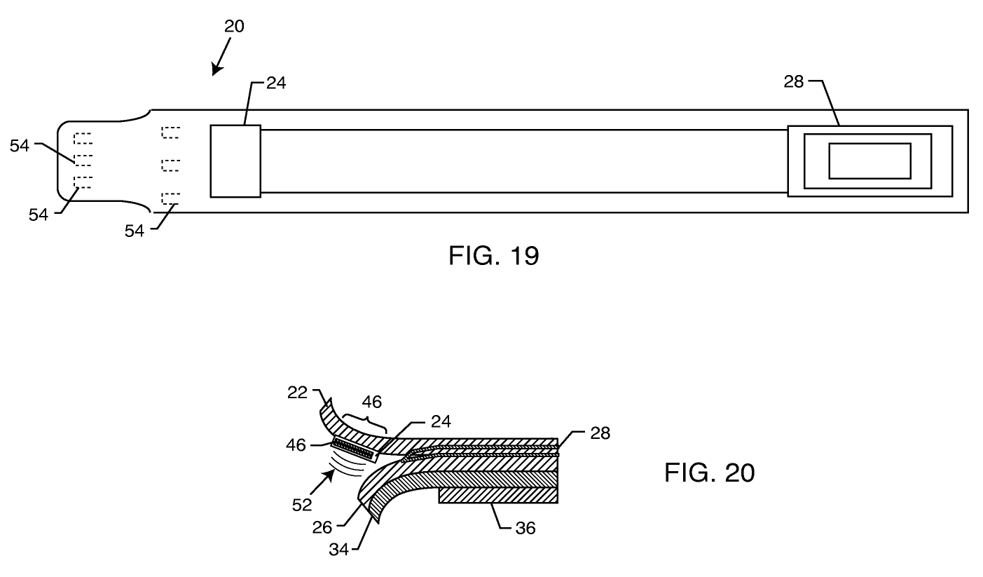

FIG. 16 depicts the wristband 20 including stress cuts or perforations 54 between the transponder 46, comprising the circuit host 24 and the small antenna 47, and the antenna 28. These stress cuts or perforations 54 increase the probability of separation of the circuit host 24 from the antenna 28 in the event of tampering or attempted removal of the wristband 20. FIGS. 17 and 18 further illustrate alternative embodiments of FIG. 16 where the stress cuts or perforations 54 are a set of angled cuts (FIG. 17) or a series of parallel cuts (FIG. 18). In addition, the antenna 28 may be replaced by the second transponder 50, comprising the second circuit host 48 and the second small antenna 49, as illustrated in FIG. 15. The stress cuts or perforations 54 are used to increase the probability of separation of the enhanced-range communication circuit formed by the coupling of the transponders 46, 50. Moreover, the stress cuts or perforations 54 may also increase the probability of separation between the circuit host 24 and the antenna 28 as generally illustrated in FIG. 19.

In each of the embodiments described above, it has been described how the identification device will be disabled if the circuit host 24 is separated from the antenna 28 or if a transponder 46 is separated from an antenna 28 or another transponder 50. Similarly, the identification device will be disabled if the antenna circuit loop is cut or broken. In any of these disabling scenarios, the circuit host 24 is preferably programmed to erase all data stored therein if the identification device becomes disabled. This is also the case in the embodiment which possesses two circuit hosts 24, 48. In addition, the circuit hosts 24, 48 may be programmed with an electronic alarm signal 52. This electronic alarm signal 52 may be configured to activate if the identification device becomes disabled as described above. The activation of this electronic alarm signal resulting from a separation from the circuit host 24 from the antenna 28 is depicted in FIG. 20.

The above described embodiments of the present invention are illustrative only and not limiting. It will thus be apparent to those skilled in the art that various changes and modifications may be made without departing from this invention in its broader aspects.

What is claimed is:

1. An identification device in the nature of a wristband, tag or label, comprising:
a first substrate having a circuit host bonded or printed on one side;
a second substrate having an antenna bonded or printed on one side;
a first bonding layer disposed between the first substrate and the second substrate substantially co-extensive with both the first substrate and second substrate but not over the circuit host;
the first substrate aligned with and bonded to the second substrate, wherein at least a portion of the antenna aligns with at least a portion of the circuit host and the aligned portions of the antenna and the circuit host are in electrical communication;
wherein the first bonding layer has an adhesive strength less than the adhesive strength of the bond between the circuit host and the first substrate and the bond between the antenna and the second substrate.

2. The identification device of claim 1, further comprising a conductive adhesive disposed between the aligned portions of the antenna and the circuit host, wherein the aligned portions of the antenna and the circuit host are bonded together by the conductive adhesive.

3. The identification device of claim 1, further comprising a second bonding layer disposed over at least a portion of a second side of the first or second substrates and a release layer covering the second bonding layer.

4. The identification device of claim 3, wherein the first bonding layer has an adhesive strength less than the adhesive strength of the second bonding layer.

5. The identification device of claim 1, wherein the antenna comprises a continuous loop that traverses substantially the entire length of the second substrate.

6. The identification device of claim 5, wherein the antenna is made from frangible material.

7. The identification device of claim 5, wherein the antenna is adjacent to the perimeter of the second substrate.

8. The identification device of claim 1, wherein the identification device is disabled if the circuit host is separated from the antenna or the antenna is cut or broken.

9. The identification device of claim 8, wherein the circuit host is programmed to erase all data stored therein if the identification device becomes disabled.

10. The identification device of claim 8, wherein the circuit host is programmed with an electronic alarm signal configured to activate if the identification device becomes disabled.

11. The identification device of claim 1, wherein the circuit host comprises a first circuit host and first transponder.

12. The identification device of claim 11, wherein the antenna is aligned with the circuit host such that the antenna is in communication range of the first transponder.

13. The identification device of claim 11, wherein the first transponder has a send-receive range less than the thickness of the first substrate.

14. The identification device of claim 11, wherein the antenna comprises a second circuit host and second transponder.

15. The identification device of claim 14, wherein the second transponder is aligned with the first transponder such that the first transponder is in communication range of the second transponder, forming an enhanced-range communications circuit.

16. The identification device of claim 15, wherein the first and second circuit hosts are programmed such that they are not enabled until the first and second transponders are brought into communication range, forming the enhanced-range communications circuit.

17. The identification device of claim 16, wherein the first and second transponders each have unique encrypted lock-and-key identifiers.

18. An identification device in the nature of a wristband, tag or label, comprising:
a first substrate having a first circuit host and a first transponder bonded or printed on one side;
a second substrate having an antenna bonded or printed on one side;
a first bonding layer disposed between the first substrate and the second substrate substantially co-extensive with both the first substrate and second substrate but not over the circuit host;
the first substrate aligned with and bonded to the second substrate, wherein at least a portion of the antenna is aligned with the first circuit host such that the antenna is in communication range of the first transponder;
wherein the first bonding layer has an adhesive strength less than the adhesive strength of the bond between the first circuit host and the first substrate and the bond between the antenna and the second substrate.

19. The identification device of claim 18, further comprising a conductive adhesive disposed between the aligned portions of the antenna and the first circuit host, wherein the aligned portions of the antenna and the first circuit host are bonded together by the conductive adhesive.

20. The identification device of claim 18, further comprising a second bonding layer disposed over at least a portion of a second side of the first or second substrates and a release layer covering the second bonding layer.

21. The identification device of claim 20, wherein the first bonding layer has an adhesive strength less than the adhesive strength of the second bonding layer.

22. The identification device of claim 18, wherein the antenna comprises a continuous loop that traverses substantially the entire length of the second substrate.

23. The identification device of claim 22, wherein the antenna is made from frangible material.

24. The identification device of claim 22, wherein the antenna is adjacent to the perimeter of the second substrate.

25. The identification device of claim 18, wherein the identification device is disabled if the first transponder is separated from the antenna or the antenna is cut or broken.

26. The identification device of claim 25, wherein the first circuit host is programmed to erase all data stored therein if the identification device becomes disabled.

27. The identification device of claim 25, wherein the first circuit host is programmed with an electronic alarm signal configured to activate if the identification device becomes disabled.

28. The identification device of claim 18, wherein the first transponder has a send-receive range less than the thickness of the first substrate.

29. The identification device of claim 18, wherein the antenna comprises a second circuit host and second transponder.

30. The identification device of claim 29, wherein the second transponder is aligned with the first transponder such that the first transponder is in communication range of the second transponder, forming an enhanced-range communications circuit.

31. The identification device of claim 30, wherein the first and second circuit hosts are programmed such that they are not enabled until the first and second transponders are brought into communication range, forming the enhanced-range communications circuit.

32. The identification device of claim 31, wherein the first and second transponders each have unique encrypted lock-and-key identifiers.

33. An identification device in the nature of a wristband, tag or label, comprising:
a first substrate having a first circuit host and a first transponder bonded or printed on one side;
a second substrate having second circuit host and second transponder bonded or printed on one side;
a first bonding layer disposed between the first substrate and the second substrate substantially co-extensive with both the first substrate and second substrate but not over either the first circuit host or the second circuit host;
the first substrate aligned with and bonded to the second substrate, wherein at least a portion of the first transponder is aligned with at least a portion of the second transponder such that they are in communication range of each other, forming an enhanced-range communications circuit;
wherein the first bonding layer has an adhesive strength less than the adhesive strength of the bond between the first circuit host and the first substrate and the bond between the second circuit host and the second substrate.

34. The identification device of claim 33, further comprising a conductive adhesive disposed between the aligned portions of the first transponder antenna and the second transponder, wherein the aligned portions of the first transponder and the second transponder are bonded together by the conductive adhesive.

35. The identification device of claim 33, further comprising a second bonding layer disposed over at least a portion of a second side of the first or second substrates and a release layer covering the second bonding layer.

36. The identification device of claim 35, wherein the first bonding layer has an adhesive strength less than the adhesive strength of the second bonding layer.

37. The identification device of claim 33, wherein the second transponder comprises a continuous loop that traverses substantially the entire length of the second substrate.

38. The identification device of claim 37, wherein the second transponder is made from frangible material.

39. The identification device of claim 37, wherein the second transponder is adjacent to the perimeter of the second substrate.

40. The identification device of claim 33, wherein the identification device is disabled if the first transponder is separated from the second transponder or the second transponder is cut or broken.

41. The identification device of claim 40, wherein the first circuit host and the second circuit host are both programmed to erase all data stored therein if the identification device becomes disabled.

42. The identification device of claim 40, wherein the first circuit host and/or the second circuit host are both programmed with an electronic alarm signal configured to activate if the identification device becomes disabled.

43. The identification device of claim 42, wherein the first and second transponders are programmed such that they are not enabled until they are assembled into the enhanced-range communications circuit.

44. The identification device of claim 43, wherein the first and second transponders each have unique encrypted lock-and-key identifiers.
